(19) United States
(12) Patent Application Publication
(10) Pub. No.: US 2019/0003159 A1
(43) Pub. Date: Jan. 3, 2019

(54) WINTERIZATION APPARATUS FOR RVs

(71) Applicant: Nicholas F. Wowk, Endicott, NY (US)

(72) Inventor: Nicholas F. Wowk, Endicott, NY (US)

(21) Appl. No.: 15/422,685

(22) Filed: Feb. 2, 2017

(51) Int. Cl. E03B 7/12; B60R 15/00; F16L 41/02

(52) U.S. Cl. CPC E03B 7/12; F16L 41/021; B60R 15/00

(57) ABSTRACT

A portable winterization system for replacing water in a recreational water system with antifreeze. An inverted container is provided for holding a volume of antifreeze, the container having an aperture at an upper portion thereof. A Tee connector has three ports orthogonally disposed with respect to one another, the upper one of the ports being connected to a lower portion of the container. A support stand is connected to a lower one of the ports of the Tee connector for supporting the Tee connector and the container. A middle one of the ports of the Tee connector is adapted to connect to a water inlet port of the recreational water system. The system can also be used to sanitize potable water lines in recreational vehicles as well as motorhomes, fifth wheels, travel trailers, boats, seasonal homes, hot tub jets, and tagalongs.

### FIELD OF THE INVENTION

This invention relates to winterization of recreational vehicles and, more particularly, to a portable apparatus that can be operated by one person for replacing water in a recreational water system with RV antifreeze (ethylene glycol).

### BACKGROUND OF THE INVENTION

As Goodwin stated in his U.S. Pat. No. 3,929,154, discussed hereinbelow, there is always a substantial problem in winterizing a structure which is not to be occupied for substantial periods of time. This may arise in connection with a residence in which it is desired not to have any heating for a while due to the occupants being away. It is particularly acute in connection with recreational vehicles which often must stand for substantial periods of time during the winter with no convenient means for heating them. Since it is customary in connection with such recreational vehicles to have a supply of water and a substantial amount of plumbing, some means must be found for insuring against freezing of the water pipes and the various plumbing equipment, such as toilet bowls, wash basins, and so forth.

More specifically, present recreational vehicle water systems do not lend to winterization by the individual owners or users. For example, one commonly used winterization procedure calls for draining the water tank and water heater, disconnecting the hot and cold water lines from the water heater, connecting the hot and cold water lines with a bypass coupling, disconnecting the water line from the water tank that goes to the water pump, placing the water line in an antifreeze container, opening all of the water lines, running the water pump, reconnecting the water line to the water tank, removing the bypass coupling from the water lines and reconnecting the water lines to the water heater, cleaning up all spillage and checking for leaks resulting from the removal and reconnection of the various water lines.

Bedient, in U.S. Pat. No. 4,286,617, also discussed hereinbelow, stated that recreational vehicle owners have the choice of either storing their recreational vehicles for the entire winter season or paying a fee to a service center for winterizing their water system after each winter use. Thus, the recreational vehicle owner has only the choice of the inconvenience of being without the recreational vehicle throughout the winter months or using the recreational vehicle and subjecting themselves to the considerable expense of having the water system professionally winterized after each winter use.

Winterizing recreational vehicles (RVs) by replacing water with RV antifreeze into recreational water systems (RWS) has customarily required at least two people. Many RV owners ensure freeze protection of their RV plumbing system by draining the clear water from the system, blowing out water in the system to aid evaporation, and refilling the full plumbing system with RV antifreeze to −50° F. or higher by one of the following processes:

a) a fixed integrated system interior to the RV plumbing system. Typically, a system that is added to the RV and requires added cost of equipment and installation;

b) an upright container of RV antifreeze outside the RV with tubing to the water inlet thereof, relying on the RV pump to bring up the antifreeze into the plumbing system; or

c) a hand pump system which also requires two people, one person being outside and the other inside the RV using various means of funnel and tubing.

Such conventional methods of winterizing are frustrating in their operation and require at least two people. It is often difficult to find a second person interested in helping out winterizing a recreational vehicle. Often, the RV owner spends considerable time looking for additional help. Thus, there is a need to reduce the number of people needed to winterize a recreational vehicle. As an improvement to current methods, what is needed is a do it yourself solution to improve the process of RWS winterization. Such a system will have a positive effect on RV ownership by reducing costs and reducing effort at home or on the road, thereby enhancing the RV camping experience.

### DESCRIPTION OF RELATED ART

U.S. Pat. No. 3,929,154, issued to Goodwin, discloses an arrangement and method for winterizing, by the use of antifreeze, a structure having hot and cold water pipes and a hot water storage tank. The arrangement involves introducing antifreeze into both the cold and hot water pipes so that the hot water tank can be drained and maintained in a drained condition during the period of winterization. The arrangement is particularly adapted for use in connection with recreational vehicles.

U.S. Pat. No. 4,236,655, issued to Humphries, discloses a container for storing and dispensing automotive fluids, comprising a single-piece, integrally formed, thin-walled member defining a hollow body having a continuous sidewall and opposite end walls, an elongated tubular nozzle integral with and extending from one of said end walls, a handle in said sidewall comprising an elongated fold in said sidewall providing a pair of facing segments of said sidewall and aligned elongated holes in said segments with the edges of said holes integrally connected. The nozzle has a flexible segment and can be flexed to and from a position adjacent to one end wall, where interlocking clamp or clamps formed on facing surfaces of the nozzle and end wall serve to lock the nozzle in a flexed position.

U.S. Pat. No. 4,286,617, issued to Bedient, discloses an antifreeze apparatus for use with a recreational vehicle water system having a main water storage tank, a water pump, a hot water heater and domestic cold and hot water supply lines. The invention comprises an antifreeze storage tank containing a supply of antifreeze, a first valve mechanism in fluid communication with the antifreeze storage tank and interposed between the water storage tank and the water pump and a second valve mechanism providing fluid communication between the water heater water inlet, the water heater hot water outlet and the domestic hot water line.

U.S. Pat. No. 4,531,538, issued to Sandt, et al., discloses a system operative in a winterizing mode for controllably filling hot and cold water supply lines with antifreeze to prevent against burst pipes. In one embodiment, the system includes a closed loop, valve containing path having a separate pump, filter and antifreeze tank.

U.S. Pat. No. 7,793,688, issued to Gross, Jr., et al., discloses a system to winterize a recreational vehicle having plumbing lines. A hose may be attached to an air compressor and a recreational vehicle winterizer fitting may be attached between the hose and a freshwater inlet connection port of the recreational vehicle. The winterizer fitting may include a nib, a landing, a first transition, a second transition, and a body having a male connector and a fifth chamber. A pressure gage, a butterfly valve, and an antifreeze additive system may be attached to the body of the winterizer fitting.

U.S. Published Patent Application No. 2016/0,040,403, applied for by Giesinger, discloses an RV winterizing method that introduces antifreeze to a RV system using a reverse flow procedure by using fittings or a coupling, where the coupling includes a band composed from a strip with a set of ends which overlap when the strip wraps around itself, a knob situated above the set of ends at a top portion of the band, wherein the knob adjust the band. A semi-tubular fitting is braced within the band where the semi-tubular fitting includes a set of lips extending up an inner wall of the band. A hole is disposed at a central bottom portion of the semi-tubular fitting. A fitting continuing from the hole wherein the band attaches to a faucet to create a watertight seal enables antifreeze to flow through the fitting into the faucet and into a plumbing system.

### SUMMARY OF THE INVENTION

In accordance with the present invention, there is provided a portable winterization system for replacing water in a recreational water system (RWS) with antifreeze. An inverted container is provided for holding a volume of antifreeze, the container having an aperture at an upper portion thereof. A Tee connector has three ports orthogonally disposed with respect to one another, the upper one of the ports being connected to a lower portion of the container. A support stand is connected to a lower one of the ports of the Tee connector for supporting the Tee connector and the container. A middle one of the ports of the Tee connector is adapted to connect to a water inlet port of the recreational water system.

It is therefore an object of the invention to provide an apparatus for winterizing an RV that can be used by an operator with no more skill than one has who can hook up camp facility water to an RV.

It is a further object of the present invention to provide an apparatus for winterizing an RV that is portable.

It is a further object of the present invention to provide an apparatus for winterizing an RV that has no special, electrical, or moving parts.

It is a further object of the present invention to provide an apparatus for winterizing an RV that is dependent on gravity feed and atmospheric pressure to operate and helps the RV RWS pump to operate with help, the pump prevented from losing its prime.

It is a further object of the present invention to provide an apparatus for winterizing an RV that will work with all if not most models of RV RWS.

It is still another object of the present invention to provide an apparatus for sanitizing potable water lines.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a photographic representation of the winterization apparatus in accordance with the present invention;

FIG. 2 is a photographic representation of the winterization apparatus shown in FIG. 1 mounted to the water inlet of the exterior of a recreational vehicle;

FIG. 3 is a photographic representation of the winterization apparatus including a container of RV antifreeze applied to the apparatus;

FIG. 4 is a schematic cross-section representation of the Tee connector used in the inventive system;

FIG. 5 is an exploded photographic representation of all parts of the winterization apparatus;

FIG. 6 is a photographic representation of a free standing embodiment of the invention;

FIG. 7 is a photographic representation of a free standing embodiment of the apparatus with height adjustment; and

FIG. 8 is a photographic representation of a control panel for use with the apparatus for sanitizing potable water lines.

Like reference numerals refer to like parts throughout the several views of the drawings.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The winterizing apparatus of the present invention, referred herein as the “system,” is used in the process of replacing water with RV antifreeze in RVs having recreational water systems (RWS), including but not limited to RVs, motorhomes, fifth wheels, travel trailers, boats, seasonal homes, hot tub jets, tagalongs, etc.

The system comprises an inverted container for holding a volume of antifreeze, a Tee connector with three ports orthogonally disposed with respect to one another, and a support stand connected to the Tee connector for supporting the Tee connector and the container. A middle one of the ports of the Tee connector is adapted to connect to a water inlet port of the recreational water system.

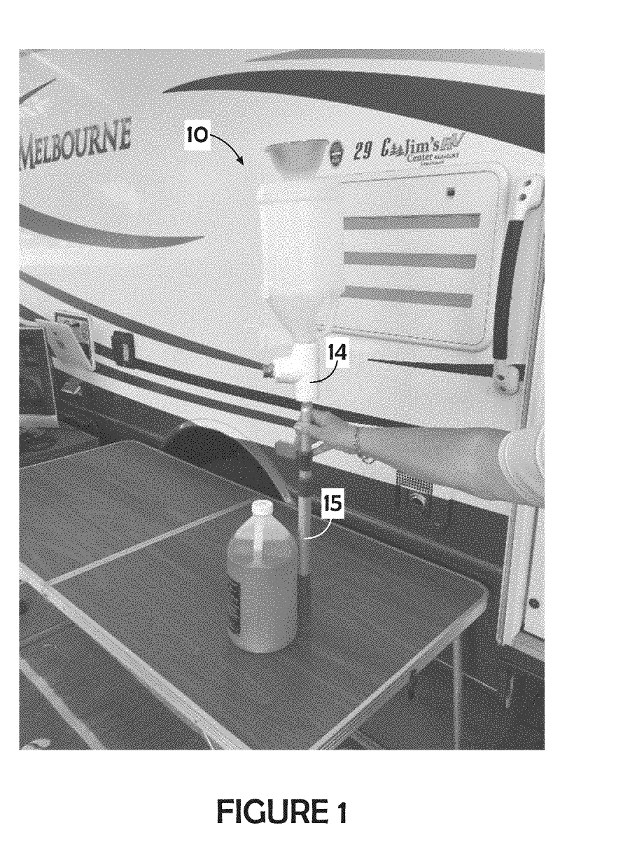

Referring now to FIG. 1, a photographic representation of the winterization apparatus 10 is shown. Apparatus 10 is a portable device for mounting on the exterior of an RWS and can also be used as a portable, free standing apparatus. Apparatus 10 consists of an empty, inverted one gallon container or bottle 12 with a fill hole, not shown, at the upper portion thereof. It should be understood that container or bottle 12 need not have a one gallon capacity; any suitable container can be used. Supporting inverted container 12 is a modified garden hose Tee connector 14, which has three ports, described hereinbelow. A telescoping support stand 15 is connected to and supports Tee connector 14 and inverted container 12.

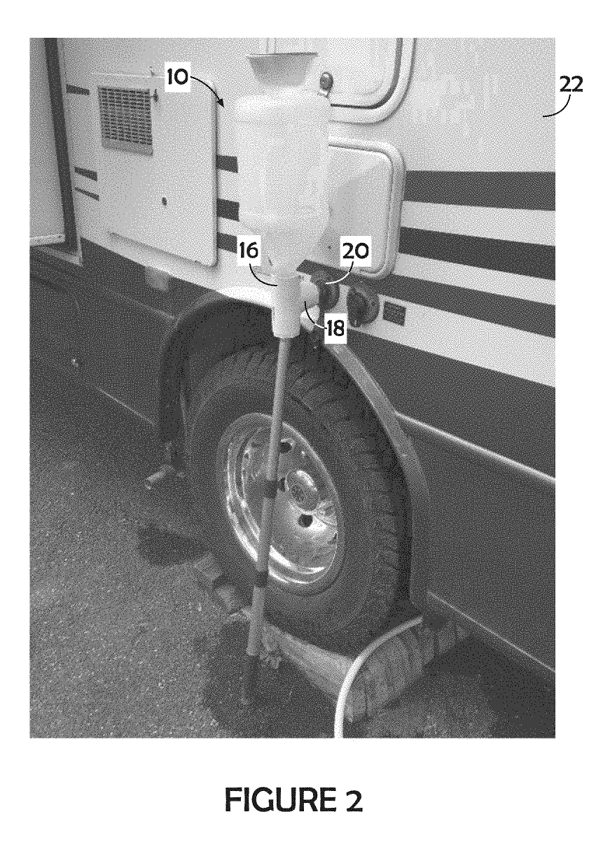

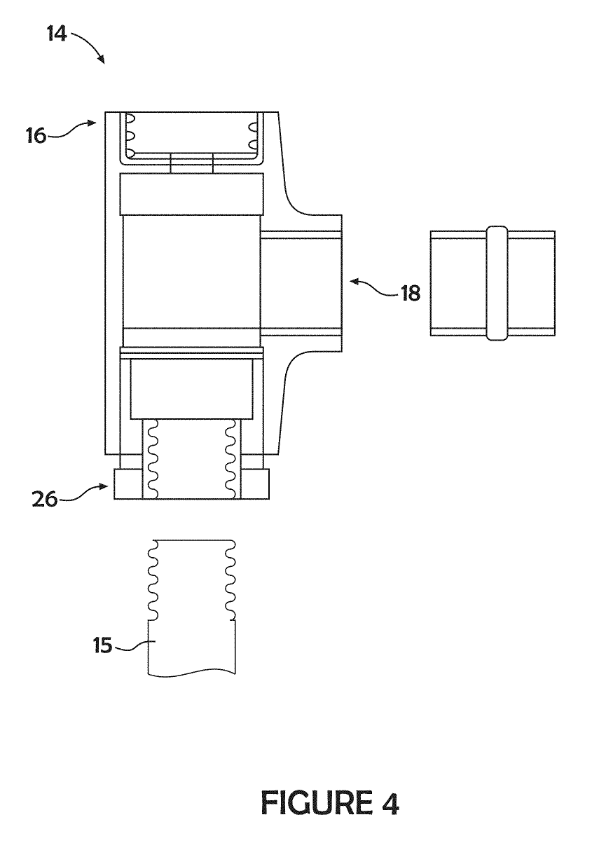

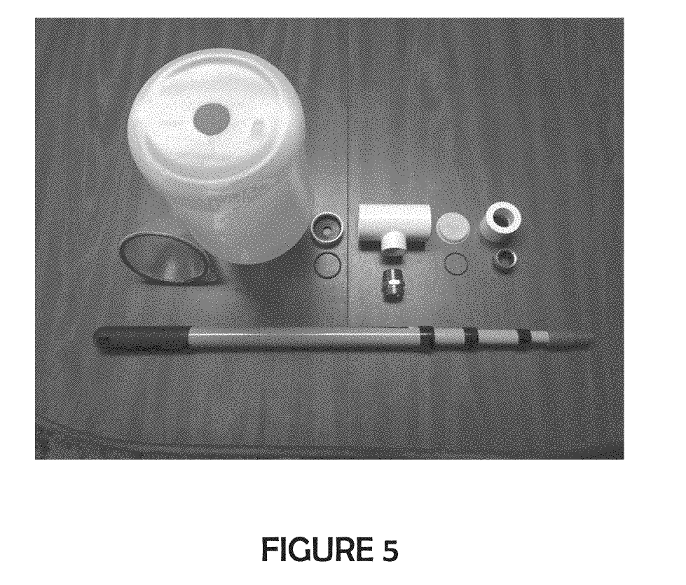

Referring now also to FIG. 2, a photographic representation of the winterization apparatus 10 is shown mounted to a recreational vehicle 22. Tee connector 14 is secured at the upper port 16 thereof to inverted container 12. Upper port 16 of Tee connector 14 includes a modified bottle cap with O ring, not shown in FIG. 2, but visible in FIGS. 4 and 5, pressed or force fitted into the Tee connector 14 to form a seal to ensure a leak-free, even flow of antifreeze from the upper portion of Tee connector 14 to the middle port 18 connection and RV water inlet port 20.

In operation, the middle port 18 of Tee connector 14 is attached to the water inlet port 20 of RV 22. Tee connector 14 can be raised or lowered to accommodate water inlet 20 by extending or compressing telescoping support stand 15 appropriately.

Tee connector 14 provides a connection at a lower port 24 for inserting a telescoping support stand 15, extending to the ground to support inverted container 12 when filled with antifreeze.

The inverted bottle 12 full of antifreeze provides a gravity feed of the antifreeze into the RWS. The fill hole in inverted bottle 12 allows atmospheric pressure to assist the flow of the antifreeze from the bottle 12 into the RWS system of RV 22. The bottle 12, being above the RWS water inlet port 20, is also above a 12 volt pump, not shown, in RV 22, thereby assisting and improving the operation of the pump in the RWS.

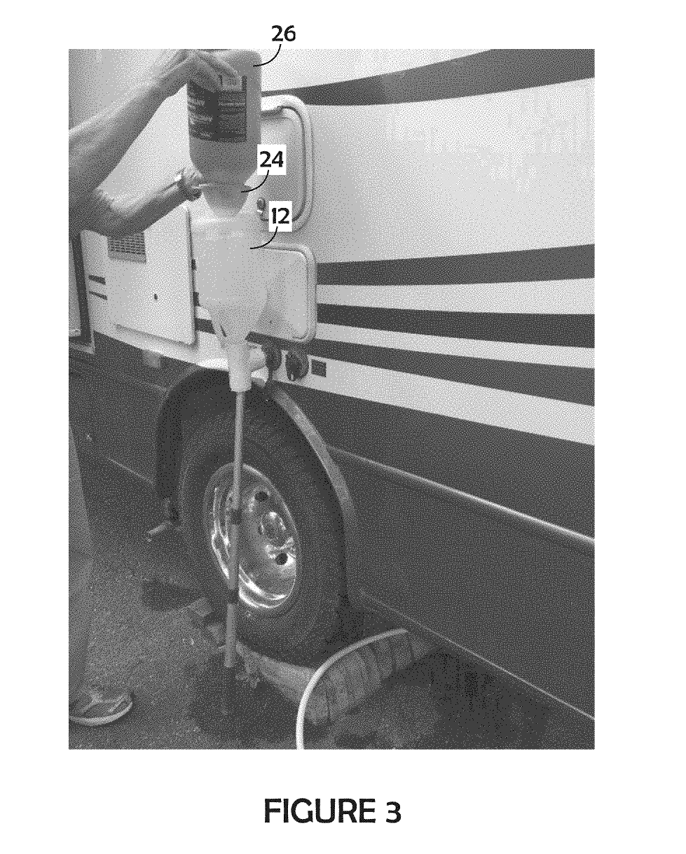

Referring now also to FIG. 3, there is shown a photographic representation of the winterization apparatus including a container of RV antifreeze 26 applied to the apparatus 10. In operation, a funnel 24 with a debris screen filter, not shown, is placed in the fill hole of inverted bottle 12 and aids the user in filling RV antifreeze into the empty container 12. Funnel 24 should remain at the fill hole during antifreeze dispensing into the RWS to prevent debris from entering into the antifreeze in the dispenser bottle.

FIG. 4 is a schematic cross-section representation of the Tee connector 14, hereinabove described, and showing upper port 16 with inserted seal 17, including an O ring, middle port 18, and lower port 26.

Referring now to FIG. 5, there is shown an exploded photographic representation of all parts of the winterization apparatus 10. All components are assembled right to left.

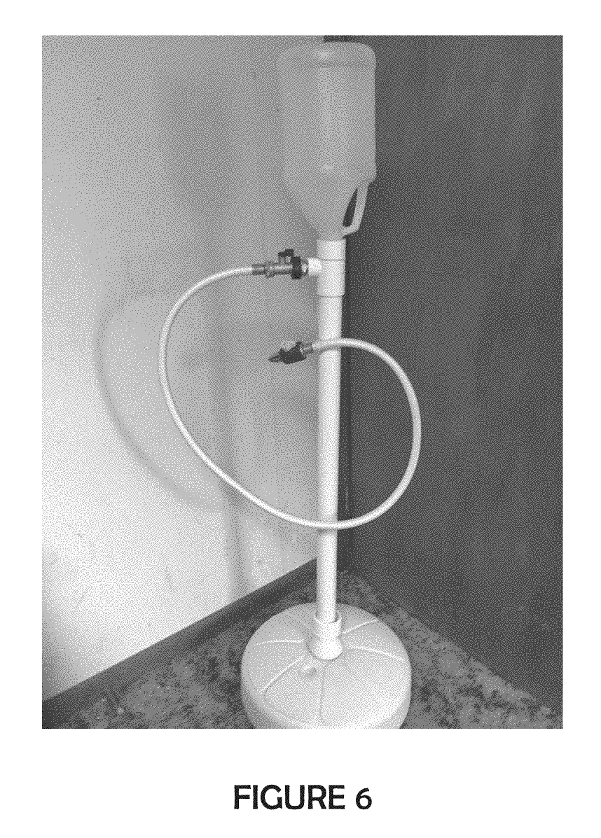

FIG. 6 is a photographic representation of a free standing embodiment of the invention. Apparatus 10 can be mounted to a water inlet or with a pinpoint nozzle, as shown. This configuration is more appropriate for boats, seasonal homes, hot tub jets and certain uniquely configured recreational vehicles.

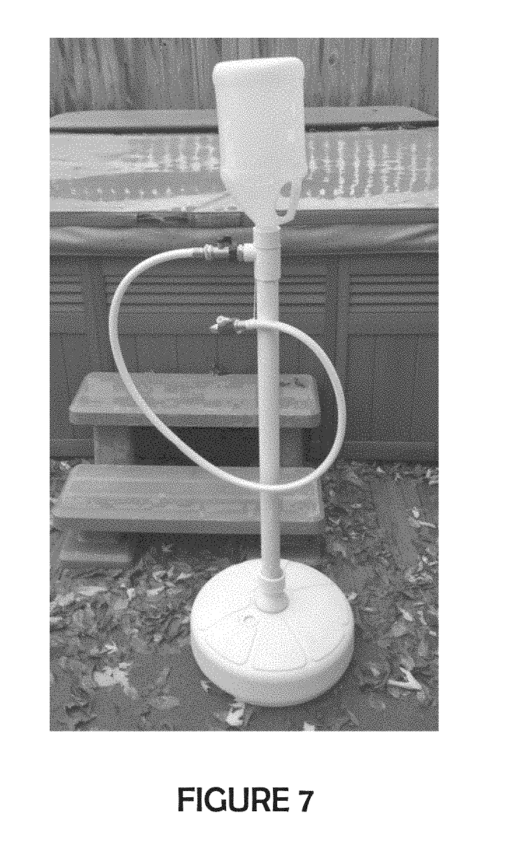

FIG. 7 is a photographic representation of a free standing embodiment of the apparatus with height adjustment to dispense antifreeze or sodium hypochlorite for sanitizing potable water lines with pinpoint accuracy to objects other than RVs, such as hot tub jets, not shown.

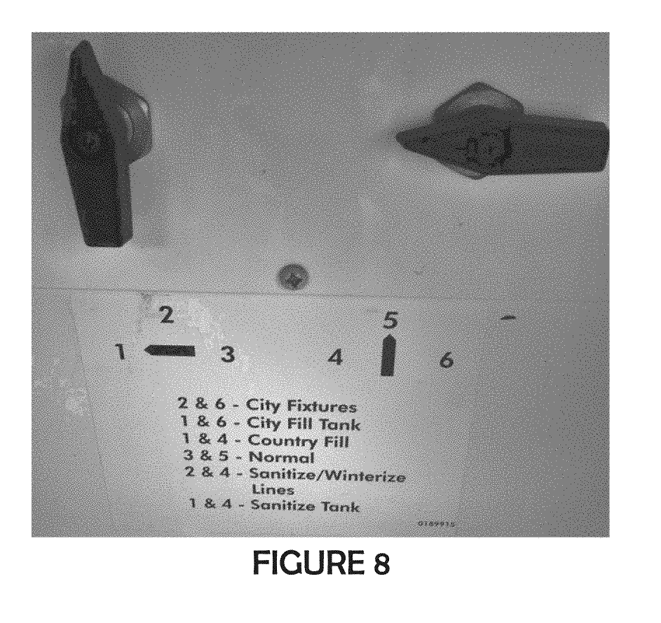

FIG. 8 is a photographic representation of a control panel for use with the apparatus 10. Such a system is conventionally used at the beginning of the camping season to sanitize potable water and lines.

The invention refills the full RWS plumbing system with RV antifreeze whenever or wherever the user chooses to winterize the RV 22. The system is set up by a single person on the exterior of the RV 22 at the water inlet 20, above the 12 volt water pump which is initially off.

In operation, after filling the system bottle with antifreeze or sodium hypochlorite when sanitizing potable water lines, the operator can then enter the RV 22 and turn on the water pump and proceed to operate all plumbing fixtures while the gravity feed of antifreeze is supplied by the system. The system will help the 12 volt pump to operate more efficiently. It is unlikely that air will enter the RV feeder line and the pump will lose its prime and stop the flow of antifreeze. This is another advantage of the inventive system, as opposed to the antifreeze supply being located below the pump in conventional methods.

After draining water from the RV RWS (with the option of blowing out excess water), the system is attached by the user to the exterior of the RV 22 at the fresh water inlet 20. After proper alignment and support of the apparatus 10 with the telescoping support stand 15, the container 12 is filled with RV antifreeze with the 12 volt pump of RV 22 off. The user then enters the RV 22, turns on the 12 volt pump, and proceeds to open faucets, not shown, in the kitchen, bathroom, toilet and shower, one at a time, until clear water has disappeared and the pink RV antifreeze runs through each fixture. If the container 12 outside RV 22 should empty (noted by the change in audible pitch of the 12 volt pump), the user refills the inverted bottle 12 outside the RV 22 and returns inside to complete the routine of opening plumbing fixture taps until sufficient RV antifreeze has been processed through the RV RWS.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A winterization system for replacing water in a recreational water system with antifreeze, comprising:
a) a container for holding a volume of antifreeze, said container having an aperture at an upper portion thereof;
b) a Tee connector having three ports orthogonally disposed with respect to one another, an upper one of said ports being connected to a lower portion of said container; and
c) a support stand connected to said Tee connector for supporting said Tee connector and said container.

2. The winterization system for replacing water in a recreational water system with antifreeze in accordance with claim 1, further comprising:
d) a removable funnel disposed at the upper portion of said container to facilitate filling said container with antifreeze.

3. The winterization system for replacing water in a recreational water system with antifreeze in accordance with claim 1, wherein said recreational water system is disposed in at least one of the group consisting of: an RV, a motorhome, a fifth wheel, a travel trailer, a boat, a seasonal home, hot tub jets, and a tagalong.

4. The winterization system for replacing water in a recreational water system with antifreeze in accordance with claim 1, wherein a lower one of said ports of said Tee connector is operatively connected to said support stand.

5. The winterization system for replacing water in a recreational water system with antifreeze in accordance with claim 1, wherein a middle one of said ports of said Tee connector is adapted to connect to a water inlet port of said recreational water system.

6. The winterization system for replacing water in a recreational water system with antifreeze in accordance with claim 5, wherein, in operation, said container is disposed above the level of a water pump in an RV.

7. The winterization system for replacing water in a recreational water system with antifreeze in accordance with claim 1, wherein said winterization system is portable.

8. The winterization system for replacing water in a recreational water system with antifreeze in accordance with claim 1, wherein said winterization system can be disassembled and stored when not in use.

9. The winterization system for replacing water in a recreational water system with antifreeze in accordance with claim 1, wherein said support stand is a telescoping stand.

10. The winterization system for replacing water in a recreational water system with antifreeze in accordance with claim 1, further comprising:
d) a seal inserted into said upper port of said Tee connector to ensure a leak-free, even flow of antifreeze from said upper portion of said Tee connector to said middle port connection thereof and to said water inlet port.

11. A system for sanitizing potable water lines in a recreational water system with sodium hypochlorite comprising:
a) a container for holding a volume of sodium hypochlorite, said container having an aperture at an upper portion thereof;
b) a Tee connector having three ports orthogonally disposed with respect to one another, an upper one of said ports being connected to a lower portion of said container; and
c) a support stand connected to said Tee connector for supporting said Tee connector and said container.

12. The system for sanitizing potable water lines in a recreational water system with sodium hypochlorite in accordance with claim 11, further comprising:
d) a removable funnel disposed at the upper portion of said container to facilitate filling said container with sodium hypochlorite.

13. The system for sanitizing potable water lines in a recreational water system with sodium hypochlorite in accordance with claim 11, wherein said recreational water system is disposed in at least one of the group consisting of: an RV, a motorhome, a fifth wheel, a travel trailer, a boat, a seasonal home, hot tub jets, and a tagalong.

14. The system for sanitizing potable water lines in a recreational water system with antifreeze in accordance with claim 11, wherein a lower one of said ports of said Tee connector is operatively connected to said support stand.

15. The system for sanitizing potable water lines in a recreational water system with antifreeze in accordance with claim 11, wherein a middle one of said ports of said Tee connector is adapted to connect to a water inlet port of said recreational water system.

16. The system for sanitizing potable water lines in a recreational water system with sodium hypochlorite in accordance with claim 15, wherein, in operation, said container is disposed above the level of a water pump in an RV.

17. The system for sanitizing potable water lines in a recreational water system with sodium hypochlorite in accordance with claim 11, wherein said sanitizing system is portable.

18. The system for sanitizing potable water lines in a recreational water system with sodium hypochlorite in accordance with claim 11, wherein said sanitizing system can be disassembled and stored when not in use.

19. The system for sanitizing potable water lines in a recreational water system with sodium hypochlorite in accordance with claim 11, wherein said support stand is a telescoping stand.
